(19) United States
(12) Patent Application Publication
(10) Pub. No.: US 2010/0013654 A1
(43) Pub. Date: Jan. 21, 2010

(54) SELF-CONTAINED MONITORING AND REMOTE TESTING DEVICE AND METHOD

(76) Inventors: Bruce A. Williams, Endwell, NY (US); Wayne M. Blackwell, Chenango Forks, NY (US)

Correspondence Address: MILES & STOCKBRIDGE PC, 1751 PINNACLE DRIVE, SUITE 500, MCLEAN, VA, 22102-3833, US

(21) Appl. No.: 12/174,369

(22) Filed: Jul. 16, 2008

(51) Int. Cl. G08B 21/00; B65G 43/00

(52) U.S. Cl. 340/676

(57) ABSTRACT

A self-contained monitoring and remote testing (SMART) unit for a mail conveyance machine includes a housing and a set of condition monitoring devices provided in the housing. The housing may be sized and adapted for conveyance by the mail conveyance machine. A ruggedized processor may be included in the housing. The processor may receive data from the set of condition monitoring devices during conveyance of the unit through the mail conveyance machine. The processor may be adapted to endure vibrations and impact during conveyance. Each of the condition monitoring devices of said set may be configured to measure a different property of the conveyance machine as the housing is conveyed therethrough. The measurements from the condition monitoring devices can be used to determine an operating condition of the conveyance machine.

The present invention relates generally to automated machinery including conveying or transporting systems, and, more particularly, to a self-contained monitoring and testing unit for monitoring and diagnosing the condition of conveying or transporting systems.

Independent machinery systems are often interconnected to achieve desired automation of a wide variety of activities, which may require a tremendous amount and variety of conveyance equipment. This interconnection of machines results in large and often complex machine systems. In order to monitor and diagnose the condition of these vital conveyance systems, a complex and resource intensive surveillance system is necessary, as each component of the conveyance equipment must be monitored by a system controller for failures. This includes monitoring sensors for jams, motors for overloads, and power supplies for outages, in addition to monitoring the system for other catastrophic failures. Besides requiring a significant amount of computing resources in order to monitor these variables, these techniques only provide an indication of a failure after it occurs, leading to significant system downtime and product damage. It may not provide a predictive measure of a failure of the conveyance machinery so that the preventative measures may be taken prior to system failure.

The present invention was conceived in light of the above-mentioned difficulties with present conveyance system monitoring techniques, and in light of a desire to achieve an efficient conveyance system monitoring, while reducing the expense and operational requirements that may accompany such monitoring. Accordingly, embodiments of the present invention may address the above-mentioned problems and limitations, among other things.

An embodiment of the present invention may include (i.e., comprise) a monitoring and remote testing unit for a mail conveyance machine. The monitoring and remote testing unit may include a plurality of sensing devices adapted for operation during conveyance of the unit through the mail conveyance machine. The plurality of sensing devices may include an accelerometer, a camera, an infrared thermometer, a static charge detector, a microphone, a strain gauge, and a hygrometer. A processor may be adapted to receive data sensed by the plurality of sensing devices during conveyance of the unit through the mail conveyance machine. A memory device may be adapted to store data from the plurality of sensing devices during conveyance of the unit through the mail conveyance machine. A battery may be adapted to provide electrical power to the plurality of sensing devices, the processor, and the memory device. A housing may contain the plurality of sensing devices, the processor, the solid-state memory device, and the battery. The housing may be sized and adapted for conveyance by the mail conveyance machine. A wireless communication device in the housing may be adapted to wirelessly transmit data sensed by the plurality of sensing devices during conveyance of the unit through the mail conveyance machine to a receiver located outside of the housing.

Another embodiment may include a system monitoring unit for a machine that conveys a product. The system monitoring unit may include a means for condition monitoring. The system monitoring unit may also include means for processing data from the means for condition monitoring. The system monitoring unit may also include a housing containing the means for condition monitoring and the means for processing data. The housing may be sized and shaped like the product. The housing may be adapted for conveyance through the machine in order to determine the condition of the machine.

Another embodiment may include a method for monitoring a condition of a conveyance machine. The conveyance machine may be configured to convey a plurality of products therethrough. The method may include, at a first time, conveying a system testing unit through the conveyance machine. The system testing unit may include a plurality of monitoring devices in a common housing. The method may also include obtaining first data indicative of an operating condition of the conveyance machine from the plurality of monitoring devices during said conveying.

### BRIEF DESCRIPTION OF THE DRAWINGS

The accompanying drawings, which are incorporated herein and constitute part of this specification, illustrate exemplary embodiments of the invention, and, together with the general description given above and the detailed description given below serve to explain the features of the invention. Throughout the figures, like reference numerals denote like elements. The figures have not been drawn to scale.

FIG. 1 is a schematic showing a top-view arrangement of components of an embodiment of a self-contained monitoring and remote testing (SMART) unit.

FIG. 2 is a schematic showing a left side-view of the SMART unit of FIG. 1.

FIG. 3 is a simplified diagram showing a side-view of a conveyance system using an embodiment of a SMART unit.

FIG. 4 is a simplified diagram showing a top-view of the conveyance system and SMART unit of FIG. 3.

FIG. 5 is a simplified diagram showing a top-view of an alternative embodiment of a conveyance system and a SMART unit.

FIG. 6 is a simplified diagram showing an embodiment of a SMART unit in a recharging and data transmission cradle.

FIG. 7 is a simplified diagram showing an embodiment of a SMART unit in a recharging cradle with wireless data transmission.

FIG. 8 is a flowchart showing a process overview of an embodiment a self-contained monitoring and remote testing method.

FIG. 9 is a flowchart showing a process overview of an alternative embodiment of a SMART method.

FIG. 10 is a flowchart showing a process detail for retesting regions of interest in the alternative embodiment of FIG. 9.

FIG. 11 is a flowchart showing a process overview of yet another embodiment of a self-contained monitoring and remote testing method.

### DETAILED DESCRIPTION

In general, the present invention is directed to a system, method, and computer program product for thoroughly diagnosing the operating conditions of a complex automated system with a large number and/or variety of conveyance or transporting equipment, such as may be found in a mail sorting machine.

An embodiment may include a self-contained monitoring and remote testing (SMART) unit with a plurality of sensing devices that can be run through the conveyance equipment just like a product normally handled by the conveyance equipment. For example, for a mail sorting machine, the housing may be shaped like a letter, flat-sized mail, or small parcel handled by the mail sorting machine. In another example, the mail sorting machine may handle machinable parcels and the housing may be sized and shaped according to machinable parcel standards.

The SMART unit can be run through a piece of conveyance equipment upon installation to provide baseline measurements of the operation of the equipment. The SMART unit can record conditions throughout the conveyance machine and report the data back to an external computer, such as a PC, handheld device, or the like. At times after installation, the SMART unit can be re-run through the piece of conveyance equipment. The subsequent readings can be compared with the baseline readings to provide a measure of variations in the system that may be indicative of problems or issues with the conveyance equipment. Thus, the SMART unit can baseline a conveyance machine at installation and compare readings for the life of the machine. Any changes in the monitored characteristics of the conveyance equipment can be used to help plan repairs before a catastrophic failure occurs. The SMART unit may record conditions through out the machine and report the data back to a PC. If variations are noted, the SMART unit can be notified to perform a more detailed examination of the area in question on its next pass through.

The SMART unit could also be used to develop new ways to optimize or adjust the conveyance machine. Additionally, the SMART unit may also be used to evaluate system performance of a conveyance machine, with the data provided by the SMART unit being used to tune the conveyance machine for optimal performance. The SMART unit could monitor system characteristics during successive runs through the conveyance machine as operating parameters are manipulated in an effort to achieve ideal system characteristics. For example, force exerted on a product by a conveyance machine may be an issue in some applications. The SMART unit may monitor the force exerted thereon, as measured by its plurality of sensing devices, as it is conveyed along the product pathway in the conveyance machine. Operating parameters of the conveyance machine may be varied on subsequent runs and the resulting force data monitored. Such operating parameters may include, but are not limited to, conveyance speed, retainer forces, and timing of mechanisms. The operating parameters of the conveyance machine may be varied until an optimal or minimal force condition is detected by the SMART unit as it is conveyed along the product pathway. The conveyance machine and SMART unit may also be configured for real-time feedback of system characteristics as the SMART unit is conveyed through the conveyance machine and real-time adjustment of operating parameters based on the feedback.

The SMART unit could also be used to compare performance of competing conveyance systems. For example, a SMART unit could be run through each competing conveyance system much as a normal piece of product would. Thus, the SMART unit would provide information on the “experience” of the product as it is handled by each conveyance system. Performance criteria may be developed and assigned to the experience of a product to assist in comparing performance. For example, in a force-sensitive application, competing conveyance systems may be rated according to the peak amount of force a product experiences as well as the total amount of time the product experiences a force above a threshold value, as measured by the SMART unit as it passes through each conveyance system.

The SMART unit can interact with the conveyance equipment, such as by wireless communication, to notify a system controller of a problem condition in the product pathway and to shut down the conveyance equipment before product becomes damaged or repairs become more costly. The SMART unit may be designed to be flexible with the conveyance equipment such that the SMART unit may bypass a suspected problem area before the conveyance equipment crashes and continue along a product pathway in the conveyance equipment. The SMART unit or the conveyance equipment can notify maintenance personnel that the problem area needs to be investigated during the next scheduled maintenance down time.

The SMART unit can be run through a piece of conveyance equipment just like a piece of product normally handled by the conveyance equipment. Thus, the SMART unit may be run through the piece of conveyance equipment simultaneously with the other pieces of product. For example, the conveyance equipment may be part of a mail sorting machine and the SMART unit may be conveyed through the mail sorting machine simultaneously with pieces of mail. The mail sorting machine may handle a particular class of mail, such as letter-size, flat-size, parcel-size, and other packages. Alternatively, the mail sorting machine may handle a combination of different mail classes.

The processor of the SMART unit can be a battery powered PC, or other embedded or single board computer, having a small footprint. The PC board may be ruggedized to handle extreme vibrations and impacts. The PC board may also have a very low power usage to optimize battery life. The batteries may be as large as could possibly fit within the frame and as powerful as possible. The SMART unit may have contacts for receiving external power while on the move in the conveyance device or sitting in a recharging station.

Alternatively, the SMART unit may be configured so as to be disposable. Thus, a battery contained in the SMART unit may be neither rechargeable nor replaceable. Instead, the battery power may be at least partially consumed during a testing run of the SMART unit through a conveyance machine. For example, the SMART unit may be constructed of low cost disposable components including a small permanent battery such that the SMART unit is substantially single use. This disposable SMART unit may be applied to conveyance machines that result in the destruction of the conveyed product. Accordingly, a user does not have to alter the product pathway of the conveyance system in order to retrieve the SMART unit.

The SMART unit may communicate with an external PC, a conveyance system controller, or other device via wireless communication. The SMART unit may also have hardwired data connections that could include video output, keyboard, mouse, USB, Ethernet, serial port, and audio output, as well as other common computer connections. The SMART unit may use any type of known memory device for bulk memory storage of measured data and/or necessary operating software. For example, the SMART unit may utilize solid-state memory devices, such as solid-state hard drives, flash cards, or similar devices. Input and output devices could be integrated as part of the PC board or supplied via an auxiliary board within the common housing of the SMART unit. Input devices to the PC board might include a plurality of sensing devices contained in the common housing with the PC board.

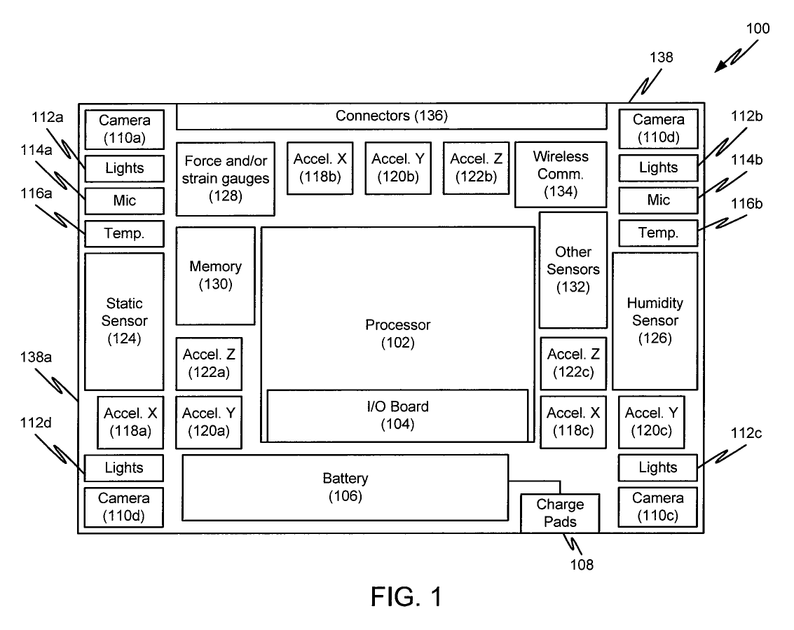

Referring to FIG. 1, a top-view schematic of an arrangement of components in an interior of a SMART unit 100 is shown. The SMART unit 100 may have a common housing or casing 138 with a plurality of condition monitoring, or sensing, devices and processing components contained therein. The plurality of sensing devices may serve as a means for condition monitoring of a machine under test. The housing 138 may be substantially rectangular, although other sizes and shapes are, of course, possible depending upon a contemplated embodiment. The housing 138 may be adapted for transport by a conveyance mechanism therethrough. For example, the housing 138 may be adapted for conveyance through a mail conveyance machine in a mail sorting machine.

An exemplary mail conveyance machine may be designed to handle mail that meets the machinable flat-size mail standard. For such an application, the housing 138 may be sized and shaped like a flat-size letter or a small parcel. For example, to meet the requirements for Automated Flat Sorting Machine (AFSM) processing, a flat-size piece should be rectangular with a height between 5 inches and 12 inches, a length between 6 inches and 15 inches, and a thickness between 0.009 inch and 0.75 inch. The maximum weight for the package should be between 13 and 20 ounces. Accordingly, the SMART unit 100 for use in such a mail sorting machine may be sized and shaped so as to meet the above requirements.

In another example, the mail conveyance machine may be designed to handle mail meeting a machinable parcel standard. For such an application, the housing 138 may be sized and shaped like machinable parcels normally handled by the mail conveyance machine. For example, to meet the requirements for machinable parcel processing, a mail piece should be rectangular with a height between 3 inches and 17 inches, a length between 6 inches and 34 inches, and a thickness between 0.25 inch and 17 inches. The weight for the package should be between 6 ounces and 35 pounds. Accordingly, the SMART unit 100 for use in such a mail sorting machine may be sized and shaped so as to meet the above requirements.

A processor 102 may be located within the housing 138 and adapted to receive data sensed by the plurality of sensing devices during conveyance of the SMART unit 100 through the conveyance machine. Thus, the processor 102 may serve as means for processing data from the plurality of sensing devices. The processor 102 may have an input/output (I/O) board 104 connected thereto, which enable data from the sensing devices to be communicated to the processor 102. Alternatively, the I/O board 104 may be integrated with the processor 102. The processor 102 may be a ruggedized PC board, adapted to handle extreme vibrations and impacts that may be encountered during transport through the conveyance machine.

The processor 102 of the SMART unit 100 may be configured to analyze data obtained from the plurality of sensing devices in different passes of the SMART unit 100 through the conveyance machine on different days to determine potential degradation of the conveyance machine over time. With the diagnostics the SMART unit 100 can supply, maintenance personnel can identify problems before they become catastrophic, order the necessary parts, and schedule the down time for the least disruptive time period.

A battery 106 may be included in the housing 138 so as to allow the SMART unit to operate remotely without a power connection during transport through a conveyance machine. The battery 106, or plurality of batteries, may be as large as could possibly fit within the housing. The battery 106 may be as powerful as possible given size and operating voltage constraints of the processor 102. The processor 102 may have a very low power usage so as to maximize battery life. The battery 106 may be rechargeable. Alternatively, the battery 106 may be replaceable.

Contact (charge) pads 108 may be provided along a portion of the housing 138. These contact pads 108 may be arranged on the housing 138 so as to receive external power while the SMART unit 100 is being conveyed along a product pathway in the conveyance machine. In an alternative embodiment, the battery 106 may be eliminated and the SMART unit may be directly powered through contact pads 108 during conveyance through the machine. In yet another embodiment, the contact pads 108 may be used to provide electrical power to the SMART unit 100 while it sits in a recharging station or cradle so as to recharge the battery 106.

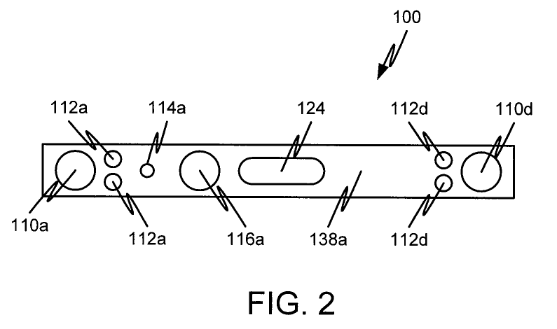

The plurality of sensing devices may be arranged throughout the housing 138 in any suitable configuration in view of size and space consideration as well as optimal placement for certain sensors based on their sensing characteristics and the targeted hardware portions of the conveyance machine. For example, a plurality of imaging systems may be located at each corner of the housing 138. Each imaging system may include a camera and a corresponding illumination system with fields of view directed outwardly from the housing so as to view portions of the conveyance machine, for example, in the same plane of the housing as it is conveyed through the conveyance machine. However, the orientation of the camera is only limited by the location of components of interest within the product pathway of the conveyance machine. Thus, the imaging systems may also have fields of view which extend perpendicular to the plane of FIG. 1. The imaging systems may be arranged with fields of view originating along an edge 138a of the housing 138. Such an exemplary configuration is shown in FIG. 2.

In an exemplary embodiment, a first camera 110a and a corresponding illumination system 112a may be located at a first corner. A second camera 110b and a corresponding illumination system 112b may be located at a second corner adjacent to the first corner. A third camera 11oc and a corresponding illumination system 112c may be located diagonal from the first corner. A fourth camera 110d and a corresponding illumination system 112d may be located at a fourth corner adjacent to the first corner and diagonal from the second corner. The cameras may take images or video of specific portions of the machine. For example, the cameras can be used to take pictures of drive components, diverters, transport screws, or other pieces of hardware of the conveyance machine that would otherwise require downtime for maintenance personnel to physically get inside of the conveyance machine to observe those pieces of hardware.

In an exemplary embodiment, the SMART unit 100 may include one or more sound sensors. For example, a pair of microphones may be provided in the housing 138. A first microphone 114a may be provided at a side of the housing 138 while a second microphone 114b may be provided at an opposite side of the housing 138. The microphones 114a, 114b may listen for noises indicative of a problem condition of the conveyance machine, such as squealing of a bearing. The microphones 114a, 114b may record sound during conveyance through the conveyance machine for analysis by the processor 102.

In an exemplary embodiment, the SMART unit 100 may also employ infrared (IR) thermometry or IR thermography to monitor temperature variations of hardware in the conveyance machine. For example, the SMART unit may have a first IR thermometer 116a located on a first side of the housing 138 and a second IR thermometer 116b located on a second side of the housing 138. The IR thermometers may be configured to monitor for hot spots, for example, in motors of the conveyance machine.

In an exemplary embodiment, the SMART unit 100 may include an accelerometer for measuring acceleration and thus motion of the housing 138. As motion of the housing 138 may vary at different locations on the housing 138, a plurality of accelerometers may be placed at different locations to fully characterize the motion of the SMART unit 100. Further, as motion may, in general, be different along different orthogonal axes, a set of three accelerometers may be provided at each different location so as to fully characterize the motion along three orthogonal axes.

For example, a first set of accelerometers may be provided a first location. The first accelerometer 118a of the first set measures acceleration along the X-axis, the second accelerometer 120a of the first set measures acceleration along the Y-axis, and the third accelerometer 122a of the first set measures acceleration along the Z-axis. Similarly, a second set of accelerometers may be provided a second location. The first accelerometer 118b of the second set measures acceleration along the X-axis, the second accelerometer 120b of the second set measures acceleration along the Y-axis, and the third accelerometer 122b of the second set measures acceleration along the Z-axis. Finally, a third set of accelerometers may be provided a third location. The first accelerometer 118c of the third set measures acceleration along the X-axis, the second accelerometer 120c of the third set measures acceleration along the Y-axis, and the third accelerometer 122c of the third set measures acceleration along the Z-axis

In an exemplary embodiment, the SMART unit 100 may include a plurality of other sensing devices in the housing 138. For example, a static charge sensor 124, a hygrometer (humidity sensor) 126, force sensors and/or strain gauges 128, and other sensors 132 may be arranged in the housing 138. Sensing devices for the other sensor 132 may include, but are not limited to, accelerometers, strain gauges, infrared thermometers, hygrometers, static detectors, cameras and lights, imaging sensors, gyroscopes, infrared cameras, temperature sensors, light detection and ranging (LIDAR) devices, radar devices, electromagnetic sensors, magnetic flux sensors, acoustic sensors, sound sensors (e.g., microphones), strain sensors, force sensors, pressure sensors, chemical sensors, humidity sensors, proximity sensors, positioning sensors, and global positioning sensors (GPS). However, the above list of sensing devices is not intended to exhaustive; other sensing devices not listed above may also be employed in the SMART unit.

In an exemplary embodiment, some of the sensing devices may be arranged so as to be dynamic or positionable within the housing 138. For example, cameras and illumination pairs may be dynamic so as to change their direction of view to follow a component of interest in the conveyance machine. The cameras may also be dynamic in that they are able to change their focal length so as to focus on a different component in the same field of view. Alternatively, one of, a portion of, or all of the sensing devices may be permanently affixed in the housing 138.

The SMART unit 100 may further be configured to determine its location within the product handling pathway of the conveyance system, so as to map the obtained data from the sensing devices to particular regions of the conveyance system. The mechanism for determining position may include a specific sensor arranged within SMART unit 100, such as a positioning sensor or GPS. Alternatively, the SMART unit 100 may determine position in the pathway based on a known configuration for the pathway and acceleration information. In yet another alternative, the conveyance system itself may track the location of the SMART unit 100 and transmit such information to the SMART unit 100 or a separate computer system for combination with the obtained data.

Not all sensing devices illustrated in FIG. 1 or listed above are required to be employed in an exemplary SMART unit. Rather, the sensing devices included in a SMART unit may be chosen according to the characteristics and contemplated failure modes of the conveying system to be tested. For example, when the primary failure mode of a machine under test is vibration in the X-direction, a single accelerometer disposed in the housing of the SMART unit may be sufficient to characterize the operating condition of the conveying machine. Thus, it is contemplated that a suite of sensing devices arranged in housing 138 of SMART unit 100 can be customized from a variety of sensing devices according to the conveying system being tested.

A memory device 130 may be provided in the SMART unit 100 to store data from the plurality of sensing devices. During conveyance of the SMART unit 100, the memory device may store data generated by the sensing devices for use by the processor 102, transmission of data to an external computer while SMART unit 100 is being conveyed, or for later transmission of data. The SMART unit 100 may utilize solid-state devices, such as solid-state hard drives, flash cards, or similar devices, for the memory device 130.

The SMART unit 100 may communicate with an external PC, a conveyance system controller, or other device via wireless communication. For example, the SMART unit 100 may include a wireless communication transceiver 134 in the housing 138. Data sensed by the plurality of sensing devices during conveyance of the SMART unit 100 through a conveyance machine and stored in memory 130 may thus be wirelessly communicated through the transceiver 134 to an associated receiver or transceiver located outside of the housing 138. Thus, the SMART unit 100 may communicate with an external PC, a conveyance system controller, or other device via wireless transceiver 134. The SMART unit may also have physical connectors 136 for connecting to standard data connectors. For example, the physical connectors 136 may include, but are not limited to, video output, S-video output, BNC connections, keyboard port, mouse port, USB port, Ethernet port, serial port, and audio output, as well as other common computer connectors.

Although shown as a substantially planar rectangle with a planar arrangement of sensing devices and processing components in FIG. 1, housing 102 of the SMART unit 100 may be configured in other sizes and shapes. For example, SMART unit 100 may be substantially three-dimensionally shaped with a three-dimensional distribution of sensing devices and processing components. Such a configuration for the SMART unit 100 may resemble in size and shape a parcel or package typically handled by a package sorting machine or the like. It is further noted that the layout of components shown in FIG. 1 is only exemplary. Other layouts and arrangements for the components are possible depending upon a contemplated embodiment.

In an exemplary embodiment, the exterior of housing 138 may be provided with indicia, which may be permanent, temporary, or both. The conveyance system under test may use the indicia on the housing 138 to customize the conveyance of the SMART unit 100 through the conveyance system. For example, when the conveyance system is a mail sorting system, the machine vision systems of the mail sorting system may be configured to recognize the indicia of the SMART unit 100 and adjust conveyance accordingly.

In an exemplary embodiment, a display panel may be provided on an exterior surface of the housing 138. The display may be configured to provide images thereon. The images may resemble surfaces or indicia of products normally handled by the conveyance system. For example, for a mail sorting system, the display may show an address or barcode so as to test the machine vision capabilities of the mail sorting system. The display may additionally be configured to provide visual information to a user regarding data stored in the SMART unit 100. The display may also be configured to display an operating condition of the SMART unit 100 (e.g., battery level, free memory, etc.) or an operating condition of the conveyance system under test.

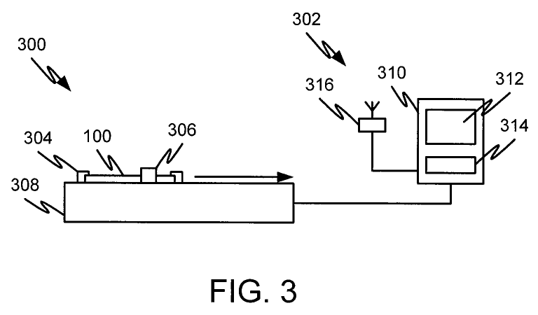

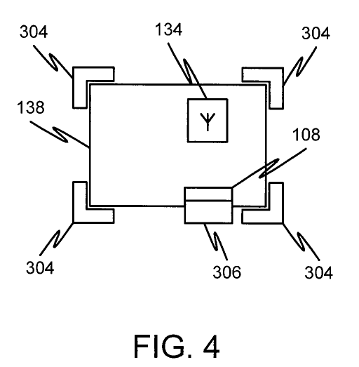

FIG. 3 shows a side-view of a system 300 having a conveyance machine 308 conveying a SMART unit 100. FIG. 4 shows a top-view of aspects of the conveyance machine 308 conveying the SMART unit 100. Transport holders 304 may be provided at each corner of the SMART unit 100 to guide the unit 100 along a product pathway in the conveyance machine 308. A power contact 306 may be provided in the conveyance machine 308 for interfacing with contact pads 108 of the SMART unit 100.

Data sensed by the plurality of sensing devices during conveyance of the SMART unit 100 through a conveyance machine 308 and stored in memory 130 may be wirelessly communicated through transceiver 134 to an associated receiver 316 of a conveyance machine controller 302. A computer 310 may receive the data from receiver 316 for further processing and/or storage. Alternatively, SMART unit 100 may only transmit operating conditions or determined problem regions to computer 302. The computer 310 may control operation of the conveyance machine 308 based on the received data. Computer 310 may also include a display 312 and a user input device 314.

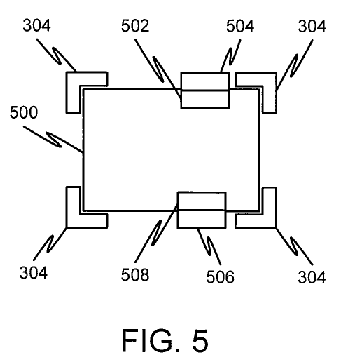

An alternative arrangement for a SMART unit is shown in FIG. 5. Instead of a wireless communication device, as illustrated in FIGS. 3 and 4, the SMART unit 500 may include a hardwired data connector 502. This connector 502 may directly interface with a corresponding data connector 504 on the conveyance machine during transport of the SMART unit 500 along a product pathway. Similar to FIG. 4, a power contact 506 may be provided in the conveyance machine for interfacing with contact pads 508 of the SMART unit 500 so as to provide power thereto.

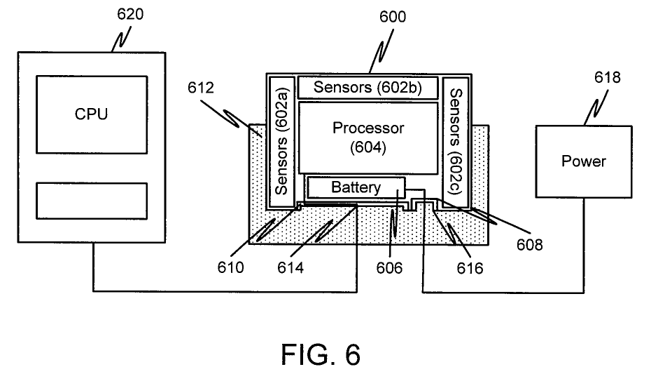

Data sensed by the plurality of sensing devices during conveyance of a SMART unit through the conveyance machine and stored in memory may also be communicated once the SMART unit has completed a run through the conveyance machine. For example, SMART unit 600 may be placed in a recharging and data transmission cradle 612 after completing a run through a conveyance machine, as shown in FIG. 6. SMART unit 600 has a plurality of sensor systems 602a, 602b, and 602c arranged in a common housing with a processor 604 and battery 606. The SMART unit 600 also has charge pads 608 and data connectors 610 located along a bottom edge of the housing. The charge pads 608 and data connectors 610 correspond to respective connections on the recharging and data transmission cradle 612. In particular, a data connector 614 on the cradle is inserted into the data connector 610 when the SMART unit is placed in the cradle 612. Accordingly, an operative data transmission connection is made between the CPU 620 and the processor 604, thereby allowing data stored in a memory device within the SMART unit 600 to be downloaded to the computer. Likewise, the power connector 616 is brought into contact with charge pads 608 when the SMART unit is placed in the cradle 612. Thus, an operative power connection is made between the battery 606 and a power source 618, thereby allowing the battery to be recharged.

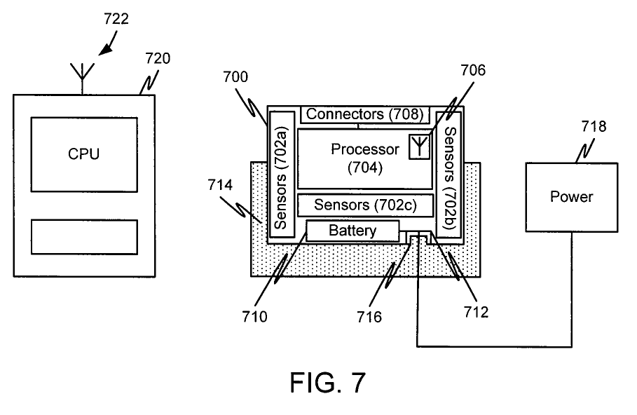

Alternatively, data stored in the SMART unit may be wirelessly transmitted to a computer while stored in a recharging cradle. For example, SMART unit 700 may be placed in a recharging cradle 714, as shown in FIG. 7. SMART unit 700 has a plurality of sensor systems 702a, 702b, and 702c arranged in a common housing with the processor 704 and battery 710. The SMART unit 700 also has charge pads 712 located along a bottom edge of the housing. The processor 704 may have a wireless communication device 706 integrated therewith for transmission of data stored in the SMART unit 700. The SMART unit 700 may also have a separate set of hardwired data connectors 708 that may allow for direct connection to a computer or other processing device. An external computer system 720 may include a wireless transceiver 722. The computer system 720 may receive data stored in SMART unit 700 via wireless data communication between the wireless transceiver 706 of the SMART unit 700 and the wireless transceiver 722 of the computer. The charge pads 712 correspond to respective connections on the recharging cradle 714. In particular, a power connector 716 is brought into contact with charge pads 712 when the SMART unit 700 is placed in the cradle 714. Thus, an operative power connection is made between the battery 710 and a power source 718, thereby allowing the battery 710 to be recharged.

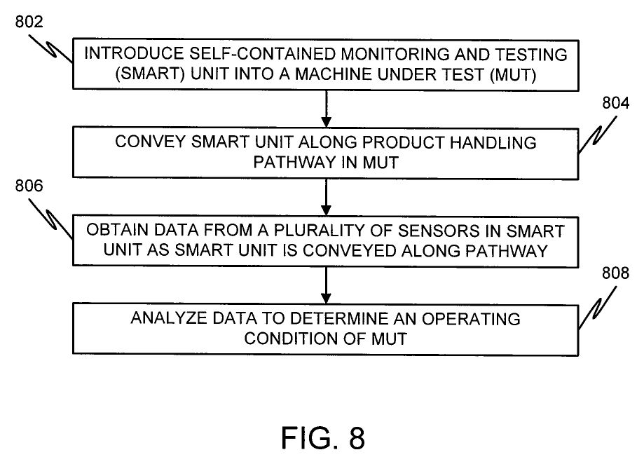

FIG. 8 is a flowchart showing a process overview of an embodiment of a method employing the SMART unit for monitoring a machine, such as a conveyance system. Beginning with step 802, a SMART unit may be introduced into a machine under test (MUT), such as a conveyance machine in a mail sorting system. The SMART unit can be introduced into the MUT in a manner similar to products normally handled by the MUT. Alternatively, the SMART unit can be introduced through a special input port so as to be conveyed along a product handling pathway in the MUT.

Proceeding to step 804, the SMART unit may be conveyed along a product handling pathway in the MUT. The MUT may simultaneously convey the SMART unit along with products normally handled by the MUT.

Proceeding to step 806, the SMART unit is configured to obtain data from a plurality of sensors contained therein while the SMART unit is simultaneously conveyed along the product handling pathway. The SMART unit may include a plurality of sensors with each sensor configured to measure a different aspect of the MUT during said conveying to thereby generate the data.

Proceeding to step 808, data obtained by the SMART unit may be analyzed to determine an operating condition of the MUT. This analysis may include noting variations between the obtained data and historical data. Variations in characteristics of the MUT may be noted to help plan repairs before a catastrophic failure occurs. The analysis may also include noting data that exceeds predetermined operating thresholds. For example, acceleration data that exceeds a predetermined limit may be determined and noted as a sign of potential failure. The analysis may also include evaluating data for signs indicative of a failure mechanism, such as the existence of bearing noise or hot spots in motors. Step 808 may be performed simultaneously as the data is obtained in step 806. Alternatively, step 808 may be performed after the SMART unit completely traverses the product handling pathway of the MUT and all data has been obtained.

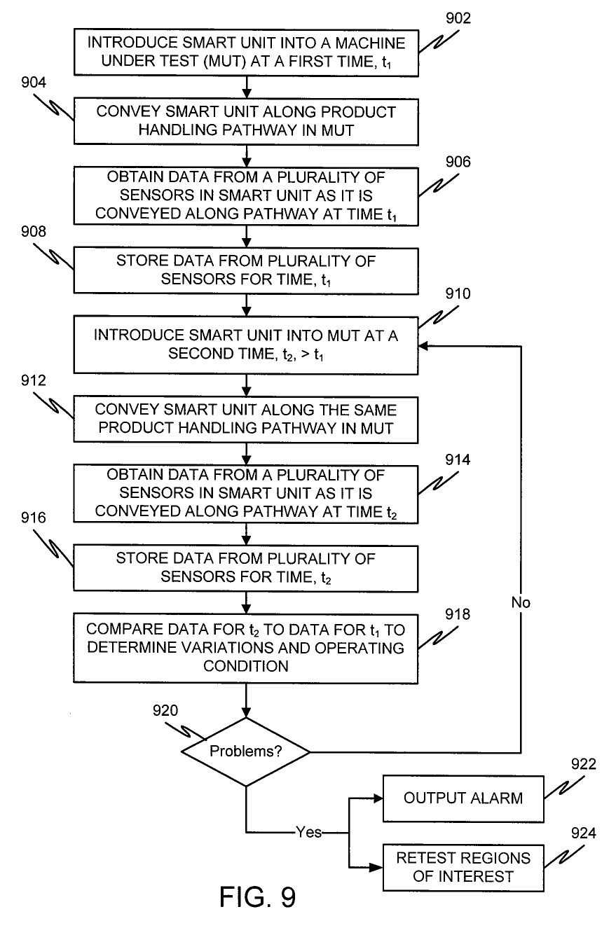

In an embodiment, the SMART unit can be run through a piece of conveyance equipment upon installation to provide baseline measurements of the operation of a MUT. The SMART unit can record conditions throughout the MUT and report the data back to an external computer or control system. At times after installation, the SMART unit can be re-run through the MUT. The subsequent readings can then be compared with the baseline readings to provide a measure of variations in the MUT that may be indicative of problems or issues. Such a method is reflected in the flowchart of FIG. 9.

Beginning with step 902, a SMART unit may be introduced into a MUT, such as a conveyance machine, at a first period of time, t₁. This first time may be at a time of installation of the MUT. Alternatively, the first time may be immediately or soon after the MUT has undergone maintenance and/or renovation. The SMART unit can be introduced into the MUT in a manner similar to products normally handled by the MUT. Alternatively, the SMART unit can introduced through a special input port so as to be conveyed along a product pathway in the MUT.

Proceeding to step 904, the SMART unit may be conveyed along a product handling pathway in the MUT. Proceeding to step 906, the SMART unit may be configured to obtain data at time t₁ from a plurality of sensors contained in the SMART unit as the unit is conveyed along the product handling pathway in step 904.

Proceeding to step 908, the obtained data may be stored. The data may be permanently stored in the SMART unit itself, for example, in a solid-state memory device contained in said unit. Alternatively, the data may be temporarily stored in the SMART unit while data is being obtained during conveyance and then transferred to a separate computer system or data storage means after conveyance.

Proceeding to step 910, at a second period of time t₂ later than t₁, the SMART unit may be re-introduced into the MUT. In particular, the SMART unit may be re-introduced into the MUT at time t₂ in a manner similar to the introduction at time t₁. Times t₁ and t₂ may be on different days. Alternatively, times t₁ and t₂ may be separated by weeks, months, or years.

Proceeding to step 912, the SMART unit may be conveyed along the same product handling pathway in the MUT. Proceeding to step 914, the SMART unit may be configured to obtain data at time t₂ from a plurality of sensors contained in the SMART unit as the unit is conveyed along the product handling pathway in step 912.

Proceeding to step 916, the obtained data at time t₂ is stored. The data may be permanently stored in the SMART unit itself, for example, in a solid-state memory contained in said unit. Alternatively, the data may be temporarily stored in the SMART unit while data is being obtained during conveyance and then transferred to a separate computer system or data storage means after conveyance.

Proceeding to step 918, the data obtained at time t₂ is compared to data obtained at time t₁. Variations in characteristics of the MUT may thus be noted by the comparison to help plan repairs before a catastrophic failure occurs. The comparison may be performed by the processor of the SMART unit or by a separate computer system that receives the data from the SMART unit.

Proceeding to step 920, regions of the product pathway having significant changes in the data between time t₁ and time t₂ that may be indicative of a problem condition of the MUT are noted. The notation may be performed by the processor of the SMART unit or by a separate computer system that receives the data from the SMART unit. If no problems are noted, the process proceeds to step 910. The process from step 910 to step 920 is thus repeated to obtain subsequent readings at later times. The subsequent readings can be compared with the baseline readings (i.e., t₁) or intermediate readings (i.e., t₂, t₃, etc.) to provide a measure of variations in the system that may be indicative of problems or issues with the MUT. Thus, the SMART unit can compare readings for the life of the machine. Any changes in the monitored characteristics of the MUT can be used to help plan repairs before a catastrophic failure occurs.

If problems are noted, the process proceeds to steps 922 and/or 924. In step 922, an alarm condition may be output. The output may be a signal generated to a control system of the MUT. The MUT may be configured to completely shut down or to shut down only particular regions in response to the alarm condition output. The alarm condition output may also be an auditory or visual alarm to notify maintenance personnel. In another variation, the SMART unit may be configured to notify maintenance personnel of issues with the MUT via wireless communication.

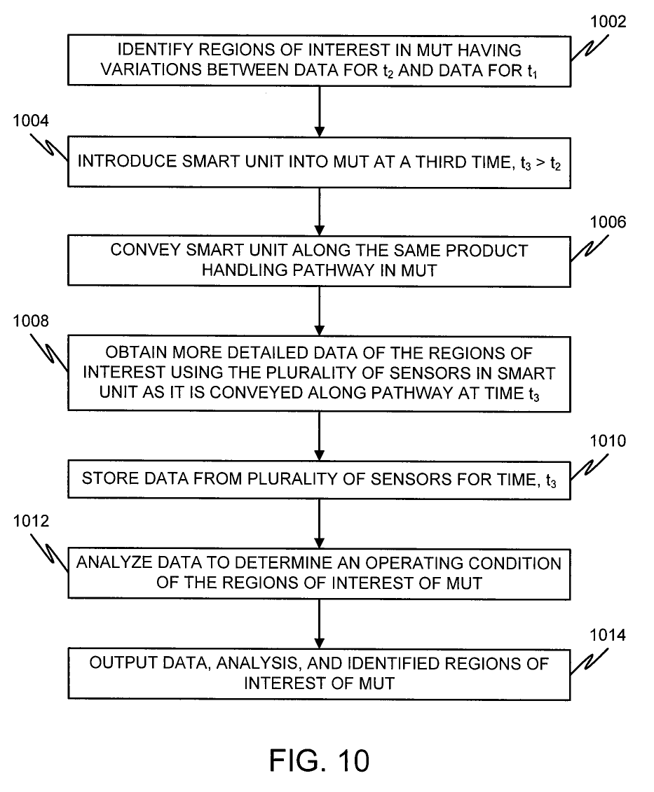

In step 924, the noted regions of interest in the product pathway of the MUT may be retested. For example, if variations are noted, the SMART unit can be configured to perform a more detailed examination of the area in question on its next pass through. Such a retesting process is illustrated in the flowchart of FIG. 10.

Beginning with step 1002, the regions of interest in the product pathway in the MUT are identified based on the variations between the data at time t₂ and time t₁. Proceeding to step 1004, at a third period of time t₃ later than t₂, the SMART unit may be re-introduced into the MUT. In particular, the SMART unit may be re-introduced into the MUT at time t₃ in a manner similar to the introduction at time t₂. Times t₂ and t₃ may be on different days. Alternatively, times t₂ and t₃ may be separated by weeks, months, or years. However, as problem areas may progressively worsen with time, the SMART unit may be immediately reintroduced after time t₂.

Proceeding to step 1006, the SMART unit may be conveyed along the same product handling pathway in the MUT. Proceeding to step 1008, the SMART unit may be configured to obtain data at time t₃ from a plurality of sensors contained in the SMART unit as the unit is conveyed along the product handling pathway in step 1006. In particular, the SMART unit may obtain more detailed data of the regions of interest using the plurality of sensors in the SMART unit. The data obtained during time t₁ thus provides a more detailed examination of the identified portions of the MUT than data obtained during time t₂.

The SMART unit may be configured to control the MUT to direct it to the regions of interest. The SMART unit may also be configured to control the MUT such that the SMART unit is able to obtain more detailed data. The conveyance speed may be adjusted to allow the SMART unit to obtain more detailed data.

Proceeding to step 1010, the obtained data at time t₃ is stored. The data may be stored in the SMART unit itself. Alternatively, the data may be temporarily stored in the SMART unit while data is being obtained during conveyance and then transferred to a separate computer system or data storage means after conveyance.

Proceeding to step 1012, the data obtained by the SMART unit at time t₃ may be analyzed to determine an operating condition of the regions of interest of the MUT. This analysis may include comparing the data obtained at time t₃ to data obtained at time t₁ and/or time t₂. The analysis may also include noting data that exceeds predetermined operation thresholds, such as accelerations that exceed a predetermined limit. The analysis may also include evaluating data for signs indicative of a failure mechanism, such as the existence of bearing noise or a hot spot in a motor. Proceeding to step 1014, the data, the analysis, and the identified regions of interest of the MUT may be output to an external system, such as the system controller for the MUT.

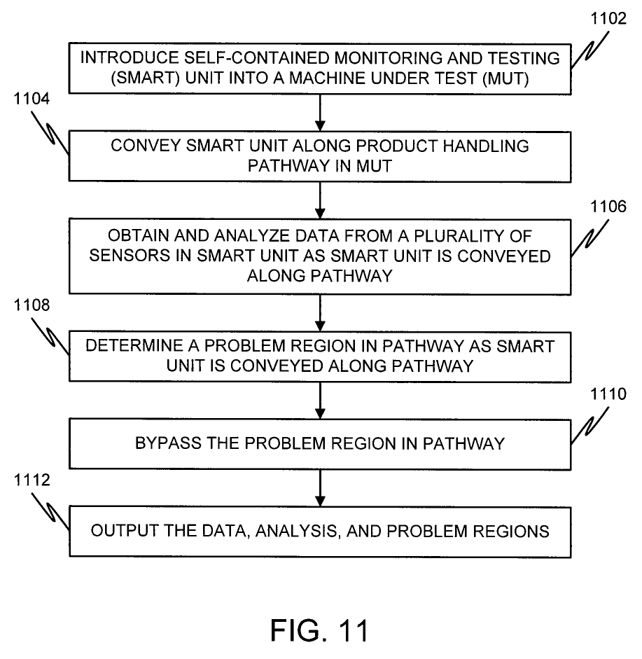

If certain portions of the product pathway of the MUT become corrupted, the SMART unit may be prevented from being conveyed therethrough. Thus, the SMART unit may be designed to be flexible with the MUT, the SMART unit may bypass a suspected problem area before the MUT crashes or the SMART unit becomes stuck. The SMART unit may thus continue along the product pathway in the MUT. The SMART unit can interact with the MUT by wireless communication to notify a MUT system controller so as to shut down the MUT before product becomes damaged or repairs become more costly. FIG. 11 is a flowchart showing a process overview of such a method.

Beginning with step 1102, a SMART unit may be introduced into a MUT, such as a conveyance machine. The SMART unit can be introduced into the MUT in a manner similar to products normally handled by the MUT. Alternatively, the SMART unit can be introduced through a special input port so as to be conveyed along a product pathway in the MUT.

Proceeding to step 1104, the SMART unit may be conveyed along a product handling pathway in the MUT. The MUT may simultaneously convey the SMART unit along with products normally handled by the MUT. Proceeding to step 1106, the SMART unit is configured to obtain and simultaneously analyze data from a plurality of sensors contained in the SMART unit as the unit is conveyed along the product handling pathway in step 1104. The SMART unit may include a plurality of sensors with each sensor configured to measure a different aspect of the MUT during said conveying to thereby generate the data. The analysis may include noting variations between the obtained data and historical data. Variations in characteristics of the MUT may be noted to help plan repairs before a catastrophic failure occurs. The analysis may also include noting data that exceeds predetermined operation thresholds, such as accelerations that exceed a predetermined limit. The analysis may also include evaluating data for signs indicative of a failure mechanism, such as the existence of bearing noise or a hot spot in a motor.

Proceeding to step 1108, the process may determine if a problem region exists in the product pathway through which the SMART unit is being conveyed based on the analyzed data in step 1106. If a problem region is determined to exist, the process may proceed to step 1110.

In step 1110, the SMART unit bypasses the problem region. For example, the SMART unit may bypass the problem region by instructing the MUT to redirect the SMART unit along a conveyance path which circumvents the problem region. The process proceeds to step 1112.

In step 1112, the data, the analysis, and the identified problem regions of the MUT may be output to an external system, such as the system controller for the MUT. In addition, the SMART unit or the MUT can notify maintenance personnel that the problem area needs to be investigated during the next scheduled maintenance down time.

It should be appreciated that the steps of the present invention may be repeated in whole or in part in order to perform a method for monitoring a conveyance machine. Further, it should be appreciated that certain steps mentioned above may be performed on a single or distributed processor. Also, certain processes, modules, and units described in the various figures of the embodiments above may be distributed across multiple computers or systems or may be co-located in a single processor or system.

Aspects of the method and system for the self-contained monitoring and testing unit for monitoring a conveyance machine may be implemented on a general-purpose computer, a special-purpose computer, an embedded or single board computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any process capable of implementing the functions or steps described herein can be used to implement embodiments of the method, system, or computer program product for monitoring a conveyance machine.

Furthermore, embodiments of the disclosed method, system, and computer program product for monitoring a conveyance machine may be readily implemented, fully or partially, in software using, for example, object or object-oriented software development environments that provide portable source code that can be used on a variety of computer platforms. Alternatively, embodiments of the disclosed method, system, and computer program product for monitoring a conveyance machine can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product for monitoring a conveyance machine can be implemented in hardware and/or software using any known or later developed systems or structures, devices and/or software by those of ordinary skill in the applicable art from the function description provided herein and with a general basic knowledge of the computer, machine automation, and sensing arts.

Moreover, embodiments of the disclosed method, system, and computer program product for monitoring a conveyance machine can be implemented in software executed on a programmed general purpose computer, a special purpose computer, an embedded or single board computer, a microprocessor, or the like. Also, the monitoring method of this invention can be implemented as a program embedded on a personal computer such as a JAVA® or CGI script, as a resource residing on a server or image processing workstation, as a routine embedded in a dedicated processing system, or the like. The method and system can also be implemented by physically incorporating certain aspects of the method for monitoring a conveyance machine into a software and/or hardware system, such as the hardware and software systems of conveyance machine systems.

It is, therefore, apparent that there is provided, in accordance with the present invention, a method, system, and computer program product for monitoring a conveyance machine. While this invention has been described in conjunction with a number of embodiments, it is evident that many alternatives, modifications and variations would be or are apparent to those of ordinary skill in the applicable arts. Accordingly, Applicants intend to embrace all such alternatives, modifications, equivalents and variations that are within the spirit and scope of this invention.

What is claimed is:

1. A monitoring and remote testing unit for a mail conveyance machine comprising:
a plurality of sensing devices adapted for operation during conveyance of the unit through the mail conveyance machine, the plurality of sensing devices including:
an accelerometer;
a camera;
an infrared thermometer;
a static charge detector;
a microphone;
a strain gauge; and
a hygrometer;
a processor adapted to receive data sensed by the plurality of sensing devices during conveyance of the unit through the mail conveyance machine;
a memory device coupled to the processor and adapted to store data from the plurality of sensing devices during conveyance of the unit through the mail conveyance machine;
a battery adapted to provide electrical power to the plurality of sensing devices, the processor, and the memory device;
a housing containing the plurality of sensing devices, the processor, the memory device, and the battery, the housing being adapted for conveyance by the mail conveyance machine; and
a wireless communication device in the housing adapted to wirelessly transmit data sensed by the plurality of sensing devices during conveyance of the unit through the mail conveyance machine to a receiver located outside of the housing.

2. The monitoring and remote testing unit of claim 1, wherein the memory device is a solid state memory device.

3. The monitoring and remote testing unit of claim 1, wherein the housing includes charge pads coupled to the battery and adapted to connect to an external power supply so as to recharge the battery.

4. The monitoring and remote testing unit of claim 1, wherein the processor is a ruggedized, low power single board computer adapted to handle extreme vibrations and impacts.

5. The monitoring and remote testing unit of claim 1, wherein the plurality of sensing devices includes a plurality of accelerometer sets, each set of accelerometers measuring acceleration along three orthogonal axes, each set arranged at a different location within the housing.

6. The monitoring and remote testing unit of claim 1, wherein the plurality of sensing devices includes a plurality of camera and illumination device pairs arranged at different locations along a periphery of the housing.

7. The monitoring and remote testing unit of claim 1, wherein the housing is sized and shaped like a product normally handled by the mail conveyance machine, the monitoring and remote testing unit being conveyed through the mail conveyance machine to monitor performance thereof.

8. The monitoring and remote testing unit of claim 7, wherein the mail conveyance machine is a mail sorting machine and the housing is sized and shaped like a parcel handled by said mail sorting machine.

9. The monitoring and remote testing unit of claim 1, wherein the processor is configured to analyze the data obtained from the plurality of sensing devices to determine potential problems in hardware of the conveyance machine.

10. The monitoring and remote testing unit of claim 1, wherein the processor is configured to analyze data obtained from the plurality of sensing devices in different passes of the unit through the mail conveyance machine on different days to determine potential degradation over time of the mail conveyance machine.

11. A system monitoring unit for a machine that conveys a product comprising:
means for condition monitoring;
means for processing data from the means for condition monitoring; and
a housing containing said means for condition monitoring and said means for processing data,
wherein the housing is sized and shaped like the product, the housing being adapted for conveyance through the machine in order to determine the condition of the machine.

12. The system monitoring unit according to claim 11, wherein the means for processing is configured to analyze data sensed by the means for condition monitoring in different passes of the unit through the conveyance machine on different days, to determine potential degradation over time of the conveyance machine.

13. The system monitoring unit according to claim 11, wherein the product is a parcel-sized piece of mail.

14. The system monitoring unit according to claim 11, wherein the means for condition monitoring comprises at least one of an accelerometer, an imaging sensor, a gyroscope, an infrared camera, an infrared thermometer, a temperature sensor, a lidar device, a radar device, an electromagnetic sensor, a magnetic flux sensor, an acoustic sensor, a sound sensor, a strain sensor, a force sensor, a pressure sensor, a chemical sensor, a proximity sensor, a position sensor, and a humidity sensor.

15. A method for monitoring a conveyance machine, the conveyance machine configured to convey a plurality of products therethrough, the method comprising:
at a first time, conveying a system testing unit through the conveyance machine, the system testing unit including a plurality of monitoring devices in a common housing, the housing sized and shaped one of the products;
during said conveying, obtaining first data indicative of an operating condition of the conveyance machine from the plurality of monitoring devices; and
simultaneously conveying the plurality of products together with the system testing unit through the conveyance machine.

16. The method according to claim 15, wherein said plurality of monitoring devices includes a plurality of sensors, each sensor configured to measure a different aspect of the conveyance machine during said conveying to thereby generate said first data.

17. The method according to claim 15, further comprising:
storing said first data;
at a second time later than said first time, conveying the system testing unit through the conveyance machine;
during said conveying at the second time, obtaining second data indicative of the condition of the conveyance machine from the plurality of monitoring devices; and
comparing the second data to said first data.

18. The method according to claim 17, further comprising:
determining variations in operation of the conveyance machine based on said comparing.

19. The method according to claim 18, further comprising:
identifying hardware of the conveyance machine that require additional examination based on the determining;
at a third time later than said second time, conveying the system testing unit through the conveyance machine; and
during said conveying at the third time, obtaining third data indicative of the condition of the conveyance machine from the plurality of monitoring devices, said third data providing a more detailed examination of the identified hardware than said second data.

20. The method according to claim 17, wherein the products are mailpieces and the conveyance machine comprises mail sorting equipment.
